(19) United States
(12) Patent Application Publication
(10) Pub. No.: US 2021/0213488 A1
(43) Pub. Date: Jul. 15, 2021

(54) PORTABLE SYSTEM FOR WASHING TOOLS

(71) Applicant: MUDMASTER INC., Escondido, CA (US)

(72) Inventor: Harold O. DeWall, Escondidio, CA (US)

(73) Assignee: MUDMASTER INC., Escondido, CA (US)

(21) Appl. No.: 17/148,126

(22) Filed: Jan. 13, 2021

Related U.S. Application Data
(60) Provisional application No. 62/960,662, filed on Jan. 13, 2020.

(51) Int. Cl. B08B 3/02; B01D 29/11; B01D 35/26; C02F 1/00; C02F 1/52; B08B 3/14; B01D 37/03; B01D 29/96; B65D 21/02; B65D 25/28; B05B 14/00; B05B 9/04

(52) U.S. Cl. CPC B08B 3/026; B01D 29/11; B01D 35/26; C02F 1/001; C02F 1/52; B08B 3/14; B08B 2203/027; B01D 29/96; B65D 21/0233; B65D 25/2805; B05B 14/00; B05B 9/0403; B01D 37/03

(57) ABSTRACT

A portable system for washing tools is disclosed. The portable system includes a first receptacle, a second receptacle, and a filtering assembly engaged with one of the first and second receptacles. The filtering assembly is configured to engage with and communicate water from one receptacle for washing tools. The water and any mud are collected in the other receptacle. When water is depleted from a receptacle, the filter assembly is transferred to the other receptacle for reuse of the water wherein the process is repeated. The filtering assembly includes a displacement element for creating a distance between a water input port and any mud at a gravitational bottom. The filtering assembly can subsequently be moved back and forth between each receptacle for continue reuse of the water for cleaning tools.

### CROSS-REFERENCE TO RELATED APPLICATIONS

This application claims benefit of priority with U.S. Provisional Application Ser. No. 62/960,662, filed Jan. 13, 2020; the entire contents of which are hereby incorporated by reference.

### BACKGROUND

### Field of the Invention

This invention relates to systems for washing tools; and more particularly, to such a system for washing drywall tools, separating particulate from water, and/or reusing or disposing the same.

### Description of the Related Art

Commonly owned U.S. Pat. No. 9,649,669, issued May 16, 2017, titled “Apparatus for Cleaning Drywall Tools”, discloses an apparatus for cleaning drywall tools; the entire contents of which is hereby incorporated by reference. The apparatus for cleaning drywall tools includes a structure supporting two tanks, one above the other. A lower tank of the two tanks holds a supply of rinse water that includes a water-clarifying agent. A water-pumping assembly pumps the rinse water from the lower tank for pressurized tool-rinsing within an upper tank of the two tanks, with the upper tank collecting the used rinse water. After mud has settled from the used rinse water, thereby resulting in a body of clarified rinse water disposed above the settled mud, an upper water-draining assembly on the upper tank drains the clarified rinse water back to the lower tank for reuse or removal. A user lowers an adjustable inlet on the upper water-draining assembly to a position within the body of clarified rinse water so that only the clarified rinse water drains, without the settled mud. The apparatus is preferably sized similar to a conventional work bench in order to enable contemporaneous tool cleaning by one or two users.

While the above apparatus for cleaning drywall tools has proven useful, it has received limited adoption in the market because, inter alia, it is not portable.

There is a need for a lightweight, portable apparatus for cleaning drywall tools, and for separating mud from water such that each of the water and the mud may be independently reused or disposed.

### SUMMARY

A lightweight, portable system for washing drywall tools, and for separating mud from water, such that each of the mud and water may be independently reused or disposed, is herein disclosed. The system generally comprises a first receptacle, a second receptacle, and a filtering assembly. The filtering assembly further comprises: a pump embodied within a housing forming an upper portion of the filtering assembly; a vertically-spanning tubular element having a proximal end adapted to couple with the pump, either directly or via a connection element therebetween, and a distal end; and a displacement element configured to rest within one of the first and second receptacles at a level where solid mud particulate meets water displaced above the particulate; wherein the distal end of the tubular element is disposed adjacent to the displacement element and configured to communicate water from within the receptacle, through a water input port and to the pump, wherein the pump is further configured to communicate the water through an outlet, a hose and to an output element, such as, without limitation, a spray nozzle.

Water and a water-clarifying agent, herein collectively the “water” is generally provided in a first of the first and second receptacles, and the filtering assembly is engaged with the first receptacle for extracting the water therefrom. A stream of water produced from the output element is used to rinse one or more tools, and the water is collected in the second receptacle. Because the tool may be covered in drywall mud or other debris, the water collected in the second receptacle may be in the form of a mixture of mud and water. However, the water-clarifying agent contained within the water is adapted to separate the mud from the water, such that the mud forms a precipitate at a gravitational bottom of the second receptacle, whereas the separated water is disposed above the precipitate. In this regard, at some point after using the water, preferably once the water is exhausted from the first receptacle, the filtering assembly can be removed from the first receptacle and engaged with the second receptacle, wherein the process is repeated to extract the water displaced above the mud, but not the mud, from the second receptacle back into the first, or otherwise into another receptacle or to ground. In this regard, mud particulate is not contaminated to the ground, and each of the water (separated form mud) and the mud itself can optionally be reused or disposed of.

### BRIEF DESCRIPTION OF THE DRAWINGS

Other features, combinations, and embodiments will be appreciated by one having the ordinary level of skill in the art upon a thorough review of the following details and descriptions, particularly when reviewed in conjunction with the drawings, wherein:

FIG. 1 shows a first perspective view revealing a front, right, and top view of a portable system for washing tools in accordance with a first illustrated embodiment;

FIG. 2 shows a second perspective view revealing a rear, left, and top view of the portable system for washing tools in accordance with the first illustrated embodiment;

FIG. 3 shows an exploded view of the key features of the portable system in accordance with the first illustrated embodiment;

FIG. 4 shows a front view of a filtering assembly for use in the portable system for washing tools in accordance with a second illustrated embodiment;

FIG. 5 shows a front view of the filtering assembly for use in the portable system for washing tools in accordance with the second illustrated embodiment;

FIG. 6 shows a closeup view of a displacement element in accordance with the second illustrated embodiment;

FIG. 7 shows a side view of the portable system for washing tools in accordance with the second illustrated embodiment; and

FIG. 8 shows a front view of the filtering assembly for use in the portable system for washing tools in accordance with a third illustrated embodiment.

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, and a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, the term “lightweight” is a relative term that means a weight that is manageable by a single person of ordinary strength in the construction field, and more particularly the drywall field, and may be any weight less than or equal to fifty pounds (50.0 lbs.).

The term “portable” means able to be easily carried or moved, having a relative size that is capable of carry by a single individual and is lightweight.

The term “displacement element” means a component that is semi-buoyant in water and heavy enough to sink below water level for resting between mud precipitate and the water within a receptacle.

The term “receptacle” means a container for holding water or what one can put things in.

The term “engaged” means to fit one part of a machine into another such that they combine and may move together as one unit.

The term “precipitate” means a solid extracted from a solution or emulsion, the solid typically settled at a gravitational bottom within a receptacle.

The term “output element” means for example and without limitation, a spray nozzle for communicating water from a receptacle for washing tools.

The term “tubular” means a hollow component used for communicating water and may comprise a cross-sectional geometry of a circle, rectangle, triangle, or any other geometry that can be appreciated by one having skill in the art.

The term “water-clarifying agent” means a substance adapted to facilitate the separation of mud and water.

Unless explicitly defined herein, terms are to be construed in accordance with the plain and ordinary meaning as would be appreciated by one having skill in the art.

### General Description of Embodiments

In a first embodiment, a portable system for washing tools is disclosed. The system comprises a first receptacle, a second receptacle, and a filtering assembly adapted to be interchangeably engaged with one of the first and second receptacles. The filtering assembly comprises a pump, a tubular element, and a displacement element. The pump is contained within a housing, and includes an inlet and an outlet each adapted to communicate water therethrough. The tubular element has a proximal end and a distal end opposite the proximal end, the proximal end being adapted to couple with the inlet of the pump, and the distal end being adapted to extend into the one of the first and second receptacles that the filtering assembly is engaged. The displacement element is coupled to the tubular element at the distal end thereof and configured for spacing a water input port a distance from one of: mud precipitate or a bottom surface of the one of the first and second receptacles. The water input port along disposed along the tubular element adjacent to the displacement element wherein the filtering assembly is configured to: removably engage the one of the first and second receptacles, extract water from the one of the first and second receptacles for washing drywall tools and communicating the water into the other of the first and second receptacles, and subsequently engage the other of the first and second receptacles for extracting water therefrom.

In some embodiments, the tubular element may comprise a plurality of concentrically-disposed portions forming a telescoping tubular element configured to extend into the one of the first and second receptacles.

Generally, the water used in the portable system may comprise a water-clarifying agent configured to separate the mud precipitate from the water.

In some embodiments, the proximal end of the tubular element may couple to the pump via a connection element extending therebetween. In other embodiments, the tubular element may couple directly to the pump.

Generally, the first receptacle and second receptable are each configured to nest within the other of the first and second receptacles.

In some embodiments, the filtering assembly may further comprise a lid having a first side and a second side opposite the first side, the first side coupled to the housing. The filtering assembly further comprises an upper block coupled to the second side, wherein the upper block is configured to guide the filtering assembly into engagement with the one of the first and second receptacles.

In some embodiments the displacement element may comprise a bottom portion having a plurality of standoffs.

In a second embodiment, a portable system for washing tools is disclosed. The system comprises a first receptacle, a second receptacle, and a filtering assembly. The filtering assembly further comprises a pump configured to communicate water, and a tubular element having the pump coupled therewith. The tubular element is adapted to extend into one of the first and second receptacles which the filtering assembly is engaged. The filtering assembly further comprises a displacement element coupled to the tubular element at the distal end thereof, and a water input port disposed along the tubular element adjacent to the displacement element.

In some embodiments, the tubular element may comprise a plurality of concentrically-disposed portions forming a telescoping tubular element configured to extend into the one of the first and second receptacles.

Generally, the water used in the portable system may comprise a water-clarifying agent configured to separate the mud precipitate from the water.

In some embodiments, the proximal end of the tubular element may couple to the pump via a connection element extending therebetween. In other embodiments, the tubular element may couple directly to the pump.

Generally, the first receptacle and second receptable are each configured to nest within the other of the first and second receptacles.

In some embodiments, the filtering assembly may further comprise a lid having a first side and a second side opposite the first side, the first side coupled to the housing. The filtering assembly further comprises an upper block coupled to the second side, wherein the upper block is configured to guide the filtering assembly into engagement with the one of the first and second receptacles.

In some embodiments the displacement element may comprise a bottom portion having a plurality of standoffs.

In a third embodiment, a filtering assembly is disclosed. The filtering assembly comprises a pump, a tubular element, and a displacement element. The pump includes an inlet and an outlet each adapted to communicate water therethrough. The tubular element includes a proximal end and a distal end opposite the proximal end, the proximal end being adapted to couple with the inlet of the pump, and the distal end being adapted to extend into one of a first receptacle and a second receptacle that the filtering assembly is engaged therewith. The displacement element is coupled to the tubular element at the distal end thereof and configured for spacing a water input port a distance from one of: mud precipitate or a bottom surface of one of the first and second receptacles, the water input port disposed along the tubular element adjacent to the displacement element.

In some embodiments, the tubular element may comprise a plurality of concentrically-disposed portions forming a telescoping tubular element configured to extend into the one of the first and second receptacles.

In some embodiments, the water used therein may comprise a water-clarifying agent configured to separate the mud precipitate from the water.

In some embodiments, the tubular element is coupled to the pump via a connection element extending therebetween.

In some embodiments, the filtering assembly further may further comprise a lid and an upper block. The lid includes a first side and a second side opposite the first side. The housing is coupled to the first side and the upper block is coupled to the second side. The upper block is configured to guide the filtering assembly into engagement with the one of the first and second receptacles.

In some embodiments, the displacement element may comprise a bottom portion having a plurality of standoffs.

### Manufacturing

The water-clarifying agent can be obtained commercially, for example and without limitation Mudmaster's Washmaster Juice® (https://www.mudmaster.com/products.html#juice2).

Generally, the first and second receptacles are made from thermoplastics such as polypropylene or polyethylene and can be manufactured by any processes known to one with skill in the art, including rotomolding or injection molding. Alternative materials that are lightweight and durable may also be used.

Generally, the pump is any kind of hydrodynamic pump that can supply a sufficient pressure and flow of water to properly clean tools containing mud and other debris.

Each of the components of the portable system and related assemblies described herein may be manufactured and/or assembled in accordance with the conventional knowledge and level of a person having skill in the art.

Moreover, while certain embodiments are described, it would be appreciated by one having skill in the art that other embodiments may be practiced in accordance with a combination of one or more features of the disclosed embodiments that are arranged in a different way.

### First Illustrated Embodiment

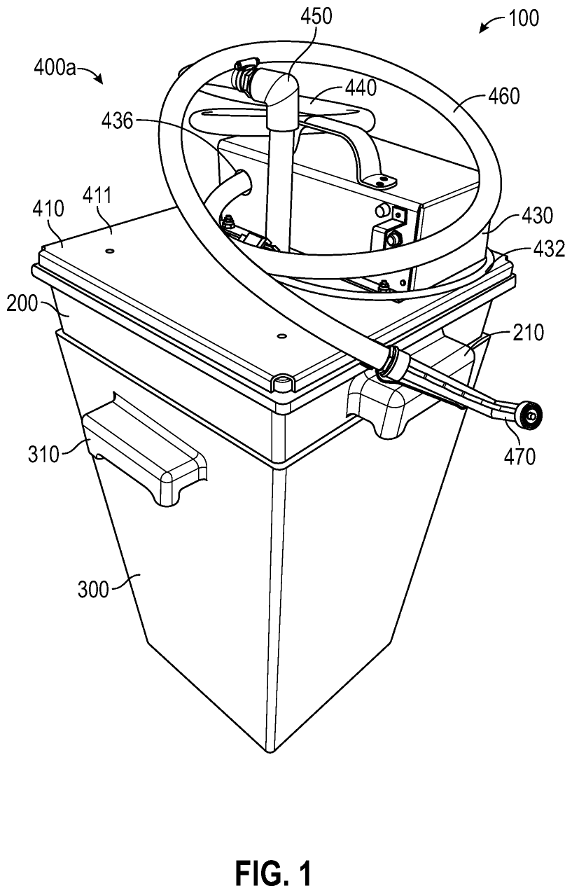

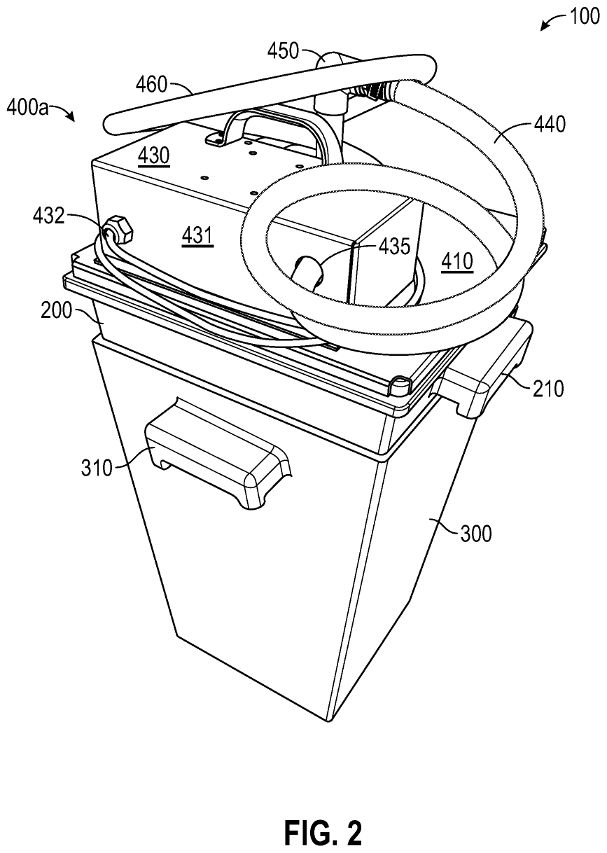

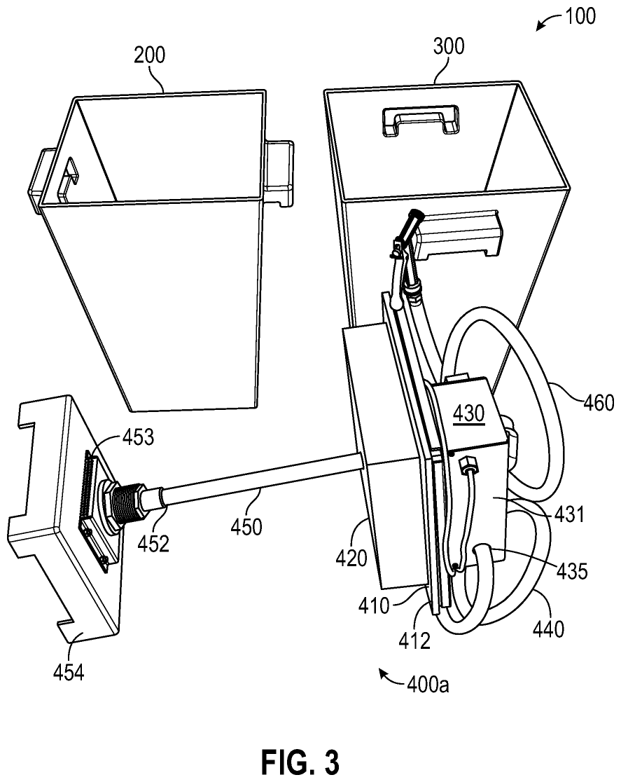

Now turning to the drawings, FIG. 1 shows a first perspective view revealing a front, right, and top view of a portable system (100) for washing tools in accordance with a first illustrated embodiment. A second receptacle (300) includes receptacle grabs (310) and is shown positioned on a floor. A first receptacle (200) is nested within the second receptacle, and also includes receptacle grabs (210). The first and second receptacles are generally identical, though may embody different shapes or designs, but preferably the first and second receptacles are configured to nest together as shown for purposes of storage efficiency and portability. The filtering assembly (400) is shown engaged with an upper rim of the first receptacle. The receptacle grabs are offset by ninety-degrees for simplified disassembly. A lid (410) of the filtering assembly having a first side (411) provides a mounting surface for a housing (430), and a pump disposed within the housing. In this view is an outlet (436) of the pump and related opening thereof where a hose (460) and output element (470) are connected to the filtering assembly. An optional handle (437) is shown on the housing. The handle provides an ergonomic feature for pulling the filtering assembly from the receptacles. A tubular element (450) is shown with a ninety-degree bend (any angle may suffice), which forms a natural grabbing point for adjusting a level of the tubular element; i.e. pushing a displacement element (FIG. 3, 454) to reach a surface of the mud or bottom surface of the receptacle. The tubular element is coupled to an inlet (FIG. 2, 435) either directly or via a connection element (440).

The output element (470) can be a spray nozzle, as shown, or any other apparatus that can be appreciated by one having skill in the art that can sufficiently supply water for cleaning tools having mud and debris.

FIG. 2 shows a second perspective view revealing a rear, left, and top view of the portable system for washing tools (100) in accordance with the first illustrated embodiment. A first receptacle (200) and a second receptacle (300) are nested together as described above, and each includes a receptacle grab (210; 310 respectively), of which the receptacle grabs are offset by ninety-degrees relative to one another. A filtering assembly (400) is shown engaged with the first receptacle, and the portable system for washing tools is shown in a storage configuration wherein the first and second receptacles are nested together. In alternative storage configurations, the filtering assembly may engage with the second receptacle. The filtering assembly is engaged with the first receptacle by a lid (410). Disposed on the lid is a housing (430), and contained within the housing is a pump (431) for communicating water. The housing and pump have an inlet (435) opening, where a connection element (440) extends into the housing and couples with the inlet. At an opposite end, the connection element is coupled to a tubular element (450), which is extended into the first receptacle. A hose (460) and the connection element are shown coiled while in the storage configuration. A power cable (432) is shown to provide power to the pump via an AC outlet. Alternative embodiments may comprise battery power, solar power, or any other power source that can be appreciated by one having skill in the art.

The first receptacle (200) is shown nested within the second receptacle (300). It will be appreciated by one having skill in the art that the second receptacle is configured to also nest within the first receptacle. In a preferable embodiment, walls of each the first and second receptacles are tapered outward to allow for receiving another receptacle. Other advantages of tapered walls include mitigating backsplash while water at high pressure is discharged into a receptacle. Additionally, if the first and second receptacles are made from thermoplastics, having tapered walls allows for easier removal from a tool during manufacturing of the first and second receptacles.

FIG. 3 shows an exploded view of the key features of the portable system (100) in accordance with the first illustrated embodiment. Here, the first receptacle (200) and second receptacle (300) are shown side-by-side, and the filtering assembly (400) is laying on its side such that various elements thereof are exposed for viewing. From top to bottom, the filtering assembly comprises a pump (431) contained within a housing (430), the pump and housing are connected to a lid (410). An upper block (420) is coupled to the lid at a second side (400). Extending through each of the lid and upper block is a tubular element (400), which may slideably translate through each thereof. At a distal end (452) of the tubular element is connected each of: a water input port (453) and a displacement element (454). Coupled to an outlet (not shown) of the pump is a hose (460). Coupled to an inlet (435) of the pump is a connection element (440), which is further coupled to the tubular element.

The first and second receptacles (200; 300) are shown having a rectangular shape. However, alternative shapes may also be used to achieve similar results. Alternative shapes may include, for example and without limitation, circular, triangular, or hexagonal. Generally, the displacement element (454) and lid (410) comprise a similar shape to that of the first and second receptacles.

In the present embodiment, water residing in a receptacle would travel through the water input port (453), up the tubular element (450), and into the pump (431) via the connection element (440). The water would then communicate through the pump and into a hose (460) for cleaning tools. Water discharged would collect into an alternative receptacle for later reuse.

### Second Illustrated Embodiment

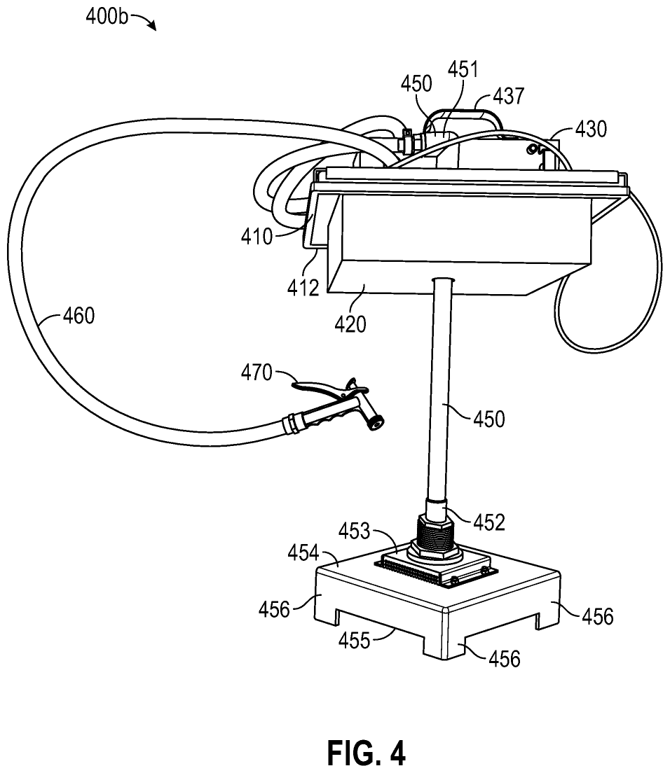

FIG. 4 shows a front view of a filtering assembly (400) for use in a portable system for washing tools in accordance with a second illustrated embodiment. The filtering assembly comprises a lid (410) having a first side (not shown) and a second side (412). Coupled to the first side is a housing (430) which encapsulates a pump. An upper block (420) is coupled to the second side, and is configured to assist with alignment into engagement with a receptacle. A tubular element (450), having a proximal end (451) and distal end (452) is coupled to the lid and extends though the lid and upper block. The proximal end is above the lid relative to ground, and at least a portion of the tubular element is configured to slide via the proximal end. Coupled at the distal end is a water input port (453) and a displacement element (454). The displacement element as shown is extended downwardly in an expanded state. The displacement element is positioned to touch an upper surface of mud or, if no mud, then to touch a bottom surface of the receptacle. Water is displaced around the displacement element for entering into the water input port. Also shown from this view is a handle (437) of the filtering assembly that is used to life and carry the filtering assembly for transferring from one receptacle to another. A hose (460) is coupled to an output element (470) and further coupled to the pump.

The displacement element (454) is shown further comprising a bottom portion (455), the bottom portion having a plurality of standoffs (456). When the filtering assembly (400) is initially introduced into a receptacle containing water, an air bubble is formed at the bottom portion of the displacement element. The air bubble contributes in displacing water which can be reused for further cleaning. Alternative designs of the displacement element can also be used which displace water and provide a distance between the water input port (453) and mud present in the receptacle.

The upper block (420) may be made of any material which is light and resistant to corrosion from water, such as a durable foam. The upper block generally comprises a shape similar to the lid (410), the displacement element (454), and any receptacle engaged therewith. One function of the upper block includes helping a user with aligning the filtering assembly (400) into a receptacle. Additional advantages of the upper block can include preventing some of the water from escaping the receptacle during transportation.

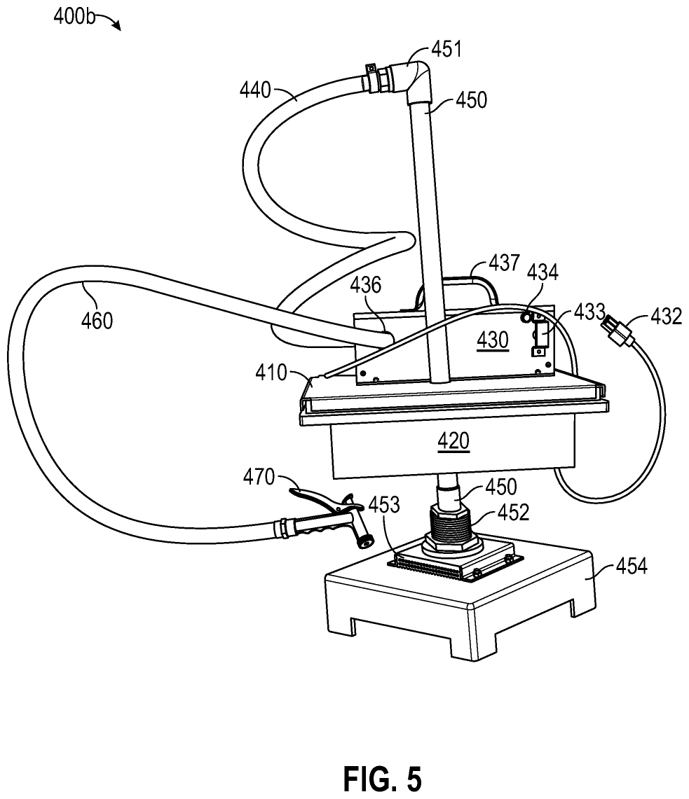

FIG. 5 shows a front view of the filtering assembly (400) for use in the portable system for washing tools in accordance with the second illustrated embodiment. The filtering assembly comprises a lid (410), an upper block (420), and a tubular element (450) extending through both the lid and upper block. A housing (430) containing a pump is coupled to the lid. A proximal end (451) of the tubular element is coupled to the pump via a connection element (440). The pump and housing further comprise an outlet (436), wherein a hose (460) and output element (470) are coupled therewith for discharging water. The tubular element further comprises a distal end (452) having a displacement element (454) coupled therewith. A water input port (453) is disposed at the distal end above the displacement element relative to a ground surface. The housing includes a handle (437), a switch (433), a power indicator (434) and a power cable (432). The power indicator is generally an LED indicator wherein the LED indicator is illuminated with the switch turned on. The LED indicator would otherwise remain off. Other variations of power indication may also be implemented.

The displacement element (454) is shown extended upwardly in a collapsed state. Here, the tubular element (450) is pulled upwardly through each of the lid (410) and upper block (420) to reach a collapsed state. The filtering assembly may be configured in the collapsed state prior to engaging a receptacle having a significant amount of mud therein, thereafter, once engaged, the tubular element is pressed down until the displacement element touches an upper surface of the mud prior to the switch (433) being turned on and the pump acting to extract water from within the receptacle.

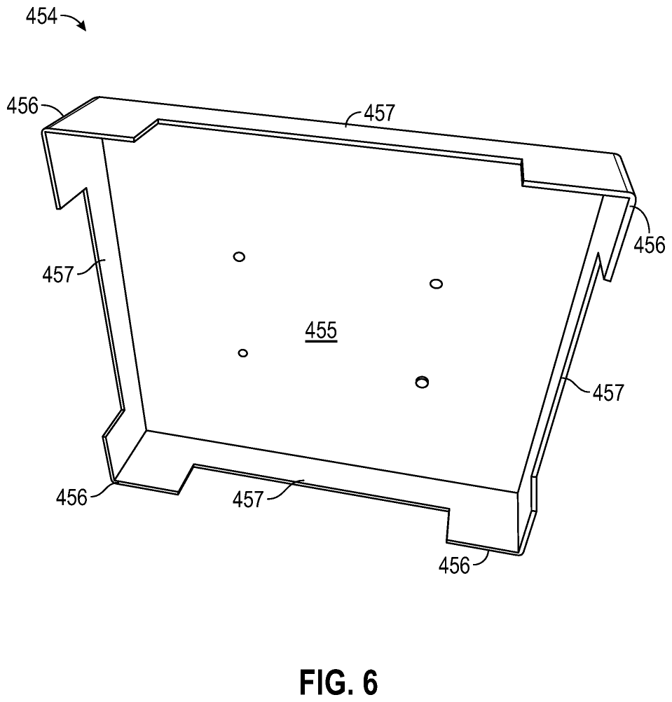

FIG. 6 shows a closeup view of a displacement element (454) in accordance with the second illustrated embodiment. The displacement element comprises a bottom portion (455) having a border (457) extending throughout a periphery of the displacement element. Extending from the border is a plurality of standoffs (456). When the displacement element initially makes contact with water contained within a receptacle, an air bubble is formed between the bottom portion, the border, and the water. The air bubble is configured to displace water at a bottom surface of the receptacle, thereby providing additional water for reuse.

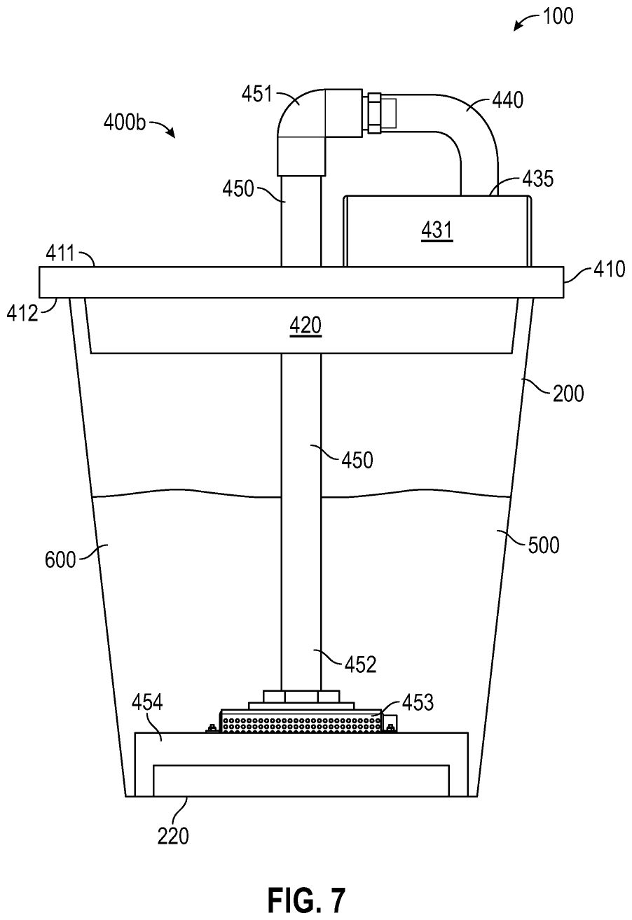

FIG. 7 shows a side view of the portable system (100) for washing tools in accordance with the second illustrated embodiment. The portable system comprises a filtering assembly (400), a first receptacle (200), and a second receptacle (not shown). The filtering assembling further comprises a tubular element (450) extending through a lid (410) and an upper block (420). The lid comprises a first side (411) and a second side (412). A pump (431) is coupled to the first side and the upper block is coupled to the second side. A proximal end (451) of the tubular element is coupled to the pump at an inlet (435) via a connection element (440). At a distal end (452) of the tubular element includes a water input port (453) and displacement element (454). The displacement element is shown touching a bottom surface (220) of the first receptacle. If mud precipitate were present, the displacement element would touch a surface of the mud precipitate prior to reaching the bottom surface of the first receptacle. Contained within the first receptacle includes water (500) and a water-clarifying agent (600). The water-clarifying agent assists with separating the water from mud precipitate that may become present after cleaning tools with the portable system.

While the filtering assembly (400) is engaged with the first receptacle (200), tools are washed inside the second receptacle using the water (500) from the first receptacle. Water, and any mud or debris are collected inside the second receptacle. After most of the water has been depleted from the first receptacle, the user can remove the filtering assembly from the first receptacle and subsequently engage the filtering assembly to the second receptacle. The water-clarifying agent (600) contributes to the separation of any mud precipitation and the water. The mud precipitation will fall below the water due to gravity, and the water will be disposed above. The displacement element (454) will then rest above the mud precipitate and displace water up to the water input port (453) for reuse to clean tools inside the first receptacle. It is recommended that any mud precipitate is removed each time the filtering assembly is transferred to a subsequent receptacle.

In a preferable embodiment, the displacement element (454) may closely match the bottom surface (220) in terms of shape and size in order to maximize water for reuse. Additionally, the displacement element and tubular element (450) may comprise an amount of weight to counteract an air bubble created by the displacement element when introduced into the water (500). If the amount of weight is sufficiently high enough, the tubular element and displacement element will remain in place inside a receptacle containing water instead of floating upwards. An alternative approach may include a locking mechanism, for example and without limitation, near the lid (410) to keep the tubular element and displacement element in place.

In some embodiments, an optional mesh filter may be used in conjunction with the water input port (453). A majority of mud precipitate will fall to a gravitational bottom, aided by the water-clarifying agent (600). However, some mud precipitate may still be present in the water (500), which is communicated through the water input port and into the pump (431). A mesh filter will help prevent mud precipitate or other debris from entering the filtering assembly (400).

The filtering assembly of the second embodiment may be combined with first and second receptacles as described in the first illustrated embodiment.

### Third Illustrated Embodiment

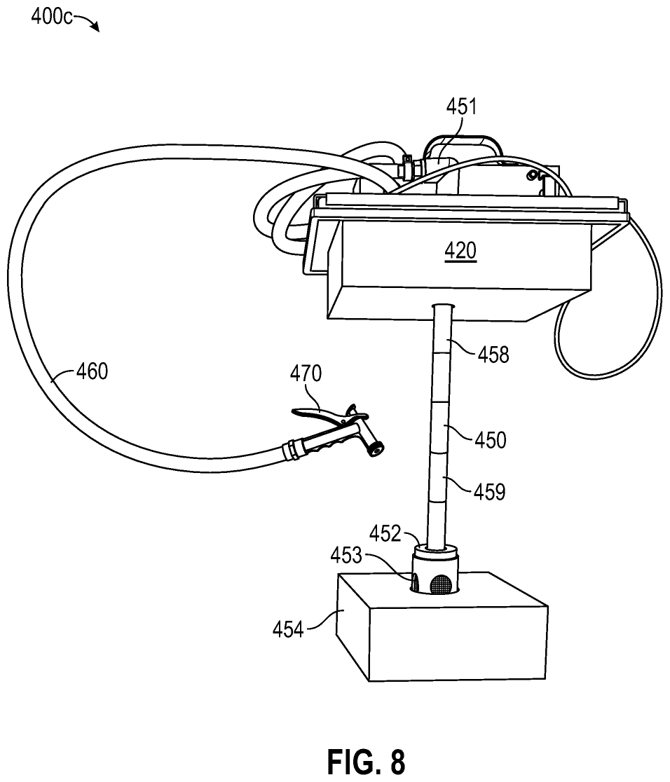

FIG. 8 shows a front view of the filtering assembly (400) for use in the portable system for washing tools in accordance with a third illustrated embodiment. In this embodiment, a tubular element (450) is shown comprising a telescoping tubular element (459), wherein the telescoping tubular element includes a plurality of concentrically-disposed portions (458). When the telescoping tubular element is pulled at a proximal end (451), the plurality of concentrically-disposed portions nest within each other and allow a displacement element (454) and water input port (453) to translate upwards from towards an upper block (420). Alternatively, when the telescoping tubular element is expanded downwards, the plurality of concentrically-disposed portions extend outward and allow a distal end (452) to translate away from the upper block. Also shown is a hose (460) and output element (470) attached to the filtering system as means for releasing water.

FIG. 8 further illustrates the displacement element (454) as a block for displacing water. The block may be solid or alternatively may include a hollow center. Alternative shapes and designs of the displacement element not disclosed can be used in conjunction with the filtering system (400) that can appreciated by one having skill in the art.

### FEATURE LIST

portable system for washing tools (100)
first receptacle (200)
receptacle grab (210)
bottom surface (220)
second receptacle (300)
receptacle grab (310)
bottom surface (320)
filtering assembly (400a; 400b; 400c)
lid (410)
first side (411)
second side (412)
upper block (420)
housing (430)
pump (431)
power cable (432)
switch (433)
power indicator (434)
inlet (435)
outlet (436)
handle (437)
connection element (440)
tubular element (450)
proximal end (451)
distal end (452)
water input port (453)
displacement element (454)
bottom portion (455)
plurality of standoffs (456)
border (457)
plurality of concentrically-disposed portions (458)
telescoping tubular element (459)
hose (460)
output element (470)
water (500)
water-clarifying agent (600)

What is claimed is:

1. A portable system for washing tools, the system comprising:
a first receptacle, a second receptacle, and a filtering assembly adapted to be interchangeably engaged with one of the first and second receptacles;
the filtering assembly comprising:
a pump contained within a housing, the pump including an inlet and an outlet each adapted to communicate water therethrough,
a tubular element having a proximal end and a distal end opposite the proximal end, the proximal end being adapted to couple with the inlet of the pump, and the distal end being adapted to extend into the one of the first and second receptacles that the filtering assembly is engaged, and
a displacement element coupled to the tubular element at the distal end thereof and configured for spacing a water input port a distance from one of: mud precipitate or a bottom surface of the one of the first and second receptacles,
the water input port disposed along the tubular element adjacent to the displacement element;
wherein:
the filtering assembly is configured to:
removably engage the one of the first and second receptacles,
extract water from the one of the first and second receptacles for washing drywall tools and communicating the water into the other of the first and second receptacles, and
subsequently engage the other of the first and second receptacles for extracting water therefrom.

2. The system of claim 1, wherein the tubular element comprises a plurality of concentrically-disposed portions forming a telescoping tubular element configured to extend into the one of the first and second receptacles.

3. The system of claim 1, wherein the water used therein comprises a water-clarifying agent configured to separate the mud precipitate from the water.

4. The system of claim 1, wherein the proximal end of the tubular element is coupled to the pump via a connection element extending therebetween.

5. The system of claim 1, wherein the first receptacle and second receptacle are each configured to nest within the other of the first and second receptacles.

6. The system of claim 1, the filtering assembly further comprising:
a lid having a first side and a second side opposite the first side, the first side coupled to the housing; and
an upper block coupled to the second side;
wherein the upper block is configured to guide the filtering assembly into engagement with the one of the first and second receptacles.

7. The system of claim 1, wherein the displacement element further comprises a bottom portion having a plurality of standoffs.

8. A portable system for washing tools, the system comprising:
a first receptacle;
a second receptacle; and
a filtering assembly comprising:
a pump configured to communicate water,
a tubular element having the pump coupled therewith, the tubular element being adapted to extend into one of the first and second receptacles which the filtering assembly is engaged,
a displacement element coupled to the tubular element at the distal end thereof, and
a water input port disposed along the tubular element adjacent to the displacement element.

9. The system of claim 8, wherein the tubular element comprises a plurality of concentrically-disposed portions forming a telescoping tubular element configured to extend into the one of the first and second receptacles.

10. The system of claim 8, wherein the water used therein comprises a water-clarifying agent configured to separate the mud precipitate from the water.

11. The system of claim 8, wherein the tubular element is coupled to the pump via a connection element extending therebetween.

12. The system of claim 8, wherein the first receptacle and second receptacle are each configured to nest within the other of the first and second receptacles.

13. The system of claim 8, the filtering assembly further comprising:
a lid having a first side and a second side opposite the first side, the first side coupled to the housing; and
an upper block coupled to the second side;
wherein the upper block is configured to guide the filtering assembly into engagement with the one of the first and second receptacles.

14. The system of claim 8, wherein the displacement element further comprises a bottom portion having plurality of standoffs.

15. A filtering assembly comprising:
a pump,
the pump including an inlet and an outlet each adapted to communicate water therethrough;
a tubular element having a proximal end and a distal end opposite the proximal end, the proximal end being adapted to couple with the inlet of the pump, and the distal end being adapted to extend into one of a first receptacle and a second receptacle that the filtering assembly is engaged therewith; and
a displacement element coupled to the tubular element at the distal end thereof and configured for spacing a water input port a distance from one of: mud precipitate or a bottom surface of one of the first and second receptacles, the water input port disposed along the tubular element adjacent to the displacement element.

16. The assembly of claim 15, wherein the tubular element comprises a plurality of concentrically-disposed portions forming a telescoping tubular element configured to extend into the one of the first and second receptacles.

17. The assembly of claim 15, wherein the water used therein comprises a water-clarifying agent configured to separate the mud precipitate from the water.

18. The assembly of claim 15, wherein the tubular element is coupled to the pump via a connection element extending therebetween.

19. The assembly of claim 15, the filtering assembly further comprising:
a lid having a first side and a second side opposite the first side, the first side coupled to the housing; and
an upper block coupled to the second side;
wherein the upper block is configured to guide the filtering assembly into engagement with the one of the first and second receptacles.

20. The assembly of claim 15, wherein the displacement element comprises a bottom portion having a plurality of standoffs.
